(19) United States
(12) Patent Application Publication
(10) Pub. No.: US 2003/0194505 A1
(43) Pub. Date: Oct. 16, 2003

(54) Accelerated implant polymerization

(76) Inventor: Michael Thomas Milbocker, Holliston, MA (US)

Correspondence Address: Donald N. Halgren, 35 Central Street, Manchester, MA, 01944, US

(21) Appl. No.: 10/255,563

(22) Filed: Sep. 26, 2002

Related U.S. Application Data
(60) Provisional application No. 60/326,240, filed on Apr. 16, 2002.

(51) Int. Cl. B05D 3/00

(52) U.S. Cl. 427/553

(57) ABSTRACT

A process for accelerating the polymerization of an implant is provided. Specifically, a process for accelerating the bond between a surgical adhesive and tissue is provided. The accelerated bonding is achieved by applying radio and/or acoustic energy to the adhesive/tissue interface such that the adhesive is coupled to the energy and absorbs a substantial quantity of the applied energy. The process comprising the steps of: a) applying said adhesive to tissue or bone, b) applying radio and/or acoustic energy to the adhesive deposited on the tissue or bone, c) dissipating the applied energy within the adhesive so as to promote adhesive/fluid mixing at the adhesive/tissue interface, d) dissipating the applied energy within the adhesive so as to activate chemical bonding at the adhesive/tissue interface, and e) dissipating the applied energy within the adhesive so as to increase the reaction rate both of the internal polymerization of the adhesive and of the adhesive/tissue interface.

### BACKGROUND OF THE INVENTION

1. Field of the Invention

This Patent Application covers an invention which relates generally to in situ polymerizing implants, and specifically to surgical adhesives and methods for accelerating their cure rate, and more particularly relates to methods and devices for applying energy to an adhesive/tissue interface to accelerate a tissue bond, and is a non-provisional patent application filing based on parent Provisional Patent Application Serial No. 60/326,240, filed Oct. 1, 2001, incorporated herein by reference.

2. Background of the Invention

A number of methods and devices are known for applying radio frequency and/or acoustic energy to adhesives in general to accelerate both internal adhesive polymerization and adhesive/substrate bonding. Such bonds include hydrogen bonding, covalent bonding, and adhesion due to Van der Walls forces.

A representative sample of the present state of the art includes Haven et al, U.S. Pat. No. 4,423,191, which teaches the curing of thermoset resins such as polyurethanes, phenolics, polyesters, and epoxies through the use of dielectrically lossy particles and with the application of an electric field having a frequency ranging from 1 MHz to 100 MHz and preferably about 1 MHz to 30 MHz. This patent however, does not relate to water or protein cured in situ polymerizing adhesives which are the subject of the present invention.

Thorsrud, U.S. Pat. Nos. 4,661,299; 4,767,799 and 4,790,965 disclose compositions intended to enhance the radio frequency sensitivity of moldable substances, disclosed sensitizers including zinc oxide, bentonite clay, and crystalline or amorphous alkali or alkaline earth metal aluminum silicate. Energy absorption enhancement by the use of additives to a curable substance as disclosed in Thorsrud do not teach the subtleties required in efficient curing; namely, the relationship between additive energy absorption and dissipation into the adhesive. The latter being critically important in uniform curing of the adhesive. Furthermore, the present disclosure involves both adhesives doped with appropriate sensitizers and adhesives without such additives.

Similarly, Schonfeld et al, U.S. Pat. No. 4,083,901, disclose a process for curing polyurethane elastomers using a curing agent.

Christensen et al, U.S. Pat. No. 6,033,203, discloses a method of using acoustic energy to soften curable compositions. The disclosure does not however, include effects particular to the present invention; namely, enhanced tissue penetration and tissue/adhesive mixing.

There are distinct advantages to rapid formation of a surgical adhesives/tissue bond. The present invention involves application of acoustic and/or radio frequency energy to a surgical adhesive and subsequent formation of a tissue/bone bond. From this point forward, the “tissue/bone” bond will be referred to simply as a tissue bond. There are several unique requirements in the present application.

Generally, energy deposition into tissue and adhesive will accelerate chemical reaction rates simply by increasing the kinetic energy of these components through thermal excitation. Thermal excitation can be enhanced, though enhancement is not required, by the addition of sensitizers. Sensitizers relate particularly to radio frequency energy and absorption of the radio waves. The sensitizers convert radio frequency energy into heat energy thereby accelerating reaction rates. In the application of sensitizers, there are several characteristics critical to their successful use. In particular, they are the dielectric constant, the loss tangent, and the dielectric loss factor. The dielectric constant is related to loss tangent and dielectric loss factor by the following equation:

Dielectric loss factor=dielectric constant×loss tangent

The “dielectric constant” is a measure of the energy storage capability of the material. While this is important in local thermalization, the “loss tangent” is equally important. The loss tangent is the ratio of the energy dissipation or dielectric loss factor of the sensitizer to its energy storage capability. In previous disclosures, the ability of the sensitizer to accept and store charge was the only consideration. In the present invention however, the storage potential is balanced against the rate of dissipation into the surrounding adhesive.

The dielectric loss factor is a measure of the ability of the sensitizer to dissipate energy in the form of heat to the surrounding adhesive. It should be noted that the sensitizer may itself be the adhesive. Considering only the dielectric constant may result in efficient storage of energy, continually, without dissipation, resulting in non-uniform curing.

### BRIEF DESCRIPTION OF THE DRAWINGS

The objects and advantages of the present invention will become more apparent when viewed in conjunction with the following drawings in which:

FIG. 1 is a schematic representation of a Hartley circuit;

FIG. 2 is a side elevational view of an electrode being applied to a tissue;

FIG. 3 is a plan view of a body portion with adhesive thereon and an rf field;

FIG. 4 is a side view of body tissue which are conductively linked;

FIGS. 5-7 display different embodiments of an adhesive arranged between two opposing surfaces for curing the adhesive;

FIG. 8 represents a sensitizer laden adhesive arranged between two opposing surfaces with polymerization energy being distributed therebetween;

FIG. 9 represents an acoustic energy generator and a graph displaying crystal oscillation relative to time;

FIG. 10 represents a side elevational view of the tissue/adhesive interface;

FIG. 11 shows a schematic representation of a combined acoustic/radio device for practicing the present invention;

FIG. 12 shows a curring probe tip;

FIGS. 13-15 display several embodiments of probe tip configurations; and

FIG. 16 shows a side elevational view of a bipolar curing tip design.

### BRIEF SUMMARY OF THE INVENTION

Generally, a substance useful as a sensitizer in accordance with the present invention includes those which have a “dissipation factor” of at least 0.1 or greater when exposed to radio wave of a frequency from 1 MHz to 100 MHz. In particular, the sensitizer in accordance with the present invention should have a dissipation factor ranging from about 0.1 to over 100, preferably from about 0.1 to about 50, and most preferably from about 0.1 to about 5. Sensitizers of the present invention may have a dielectric constant ranging from about 0.1 to over 2000.

Although the present invention does not require the addition of a sensitizer, examples of sensitizers include phosphate and phosphonate compounds. These compounds are advantageous because of a large dipole moment receptive to the specified frequency of radio waves introduced to cure the system. Phosphate compounds which may work as sensitizers include various bone phosphates, tricresyl phosphate, tributyl phosphate, and propylated phosphates.

Moreover, any phosphonated compound having a phosphate-oxygen bond having enough dipole to be receptive to the frequency of energy introduced into the system will be effective in accordance with the present invention. Examples include dimethyl methyl phosphonate, trichloropropyl phosphonate, diethyl 2-hydoxy ethyl amino phosphonate, and the like. Generally, the concentration of these compounds will range from about 0.1 wt-% to 25 wt-%, preferably from about 0.5 wt-% to 10 wt-% and most preferably from about 1 wt-% to about 7 wt-%.

Furthermore, isocyanate capped polyols and other in situ polymerizing adhesives including glutaraldehyde polymerization (available through i.e. Bioglue, Cryolife, Inc.), activated polyethylene glycol (available through i.e. FocalSeal, Genzyme, Inc.; CoStasis, Cohesion, Inc.), cyanoacrylate (available through i.e. Dermabond, Closure Medical, Inc.) and fibrin glues can be made more effective by the addition of radio frequency and acoustic energy during the curing process.

With respect to acoustic energy application, the functionality and effect of application of such energy to an adhesive/tissue system promotes different bond characteristics. Namely, the present invention relates particularly to bonds formed between tissue and adhesive by promoting bonding, either by covalent, hydrogen or Van der Wall coupling. Additionally, internal polymerization of the bulk of the adhesive is important. Internal polymerization can be enhanced by mechanical mixing induced by acoustic energy or by alignment of molecular constituents by radio frequency excitation, by the creation of active radicals, or by thermal excitation.

Acoustic energy causes the adhesive to flow into voids in the tissue, and incrementally heats the adhesive to assist in its polymerization, both internally and with tissue. Ultrasonic energy aids in mass transport of reactive constituents, such as fluids and proteins into the adhesive and conversely adhesive into tissue constituents and structures. Furthermore, it increases the probability of nucleation. This feature is particularly useful in promoting bond strength of adhesives which liberate a gaseous byproduct. In particular, acoustic energy tends to reduce the viscosity of the bulk adhesive, increase the transport of formed bubbles to the adhesive surface and promote release of the gaseous component, the formation of smaller bubbles, and in general increase the homogeneity and tensile strength of the bulk component of the adhesive bond.

It is an object of the present invention to provide a process for accelerating and strengthening the reaction and bond of a polymeric solution with tissue.

It is yet another object of the invention to provide a method and means for delivering radio frequency and acoustic energy to an uncured adhesive/tissue interface to enhance bond strength.

Additional objects, advantages and novel features of the invention will be set forth in part in the description which follows, and in part will become apparent to those skilled in the art upon examination of the following, or may be learned by practice of the invention.

The invention thus comprises a curing device for promoting polymerization of a medical implant site in mammalian tissue, consisting of: a radio frequency energy source and pair of radio frequency electrodes; and an acoustic energy source and a mechanical oscillator. The curing device may consist of a radio frequency energy source and a pair of electrodes. The curing device may consist of an acoustic energy source and a mechanical oscillator. The mechanical oscillator may comprise a piezoelectric crystal. One of said pair of radio frequency energy electrodes may be is attached distal to the implant site and generally electrically coupled to skin; and the other of the pair of radio frequency electrodes may form an element of a probe for selective excitation of the implant site. Both of the pair of radio frequency energy electrodes may be arranged on a probe for locally affecting implant cure in the implant site. The device may be arranged on a surgical robotic arm. The radio frequency energy electrodes may have a shaped distal surface to affect a particular shaped surgical repair site. The radio frequency energy may range from 1 to 100 MHz. The radio frequency energy may range from 1 to 3 MHz and the device may include an in situ polymerizing agent comprised of a polyisocyanate capped polyol. The radio frequency energy source may have a potential peak ranging from 100 to 10,000 volts. The curing device may include a sensitizer in the implant site, and the acoustic energy source may emit a traveling wave in the implant site having a wavelength which is at least twice the diameter of the molecules of the sensitizer compound present in said implant.

The invention may also include a process for increasing the speed of polymerization in an in situ polymerizing compound at a mammalian implant site, comprising the steps of: application to tissue of an in situ polymerizing agent; and excitation of the in situ polymerizing agent with either a radio frequency signal or an acoustic energy signal; coagulating blood in the implant site by the energy signal; enhancing the implant excitation efficacy of the polymerzing compound by adding a sensitizer to the compound. The sensitizer may comprise a phosphonated compound having a phosphate-oxygen bond having a dipole moment receptive to radio frequency energy. The concentration of the phosphonated compound may ranges from 0.1 wt-% to 25 wt-%. The in situ polymerizing agent may comprise a polyisocyanate capped polyol. The in situ polymerizing agent may includes a glutaraldehyde polymerization step. The in situ polymerizing agent may include an activated polyethylene glycol. The in situ polymerizing agent may include a cyanoacrylate. The in situ polymerizing agent may includes fibrin. The in situ polymerization and treatment of tissue may be performed with a robotic surgical platform. The process may include the step of: shaping the polymerized implant before the implant is polymerized. The process of polymerization may be accomplished in a stepwise fashion. The polymerized implant may be caused to infiltrate target tissue by an application of acoustic energy thereto.

### DETAILED DESCRIPTION OF THE PREFERRED EMBODIMENTS

The term “surgical adhesive” as used herein is meant to include any therapeutic or otherwise implantable, (preferably medical) compound that is capable of polymerizing in situ. Surgical adhesives useful in conjunction with the present invention include for example: fibrin based, collagen based, polyethylene oxide based, hyaluronic acid based, cyanoacrylated base, polyisocyanate based adhesives and sealants. The term “polymer” as used herein is intended to include both oligomeric and polymeric materials, i.e., compounds which include two or more monomeric units. The term is also intended to include “copolymeric” materials, i.e., containing two or more different monomeric units. “Carriers” or “vehicles” as used herein refer to carrier materials suitable for implantation, and include any such materials known in the art, e.g., diluents, binders, granulating agents, disintegrants, lubricating agents, colorants, contract agents, and the like. The term “adhesive” as used herein refers to any in situ polymerizing agent.

More specifically, the adhesives and sensitizer/adhesive combinations of the present invention may be activated by any device capable of directing electromagnetic or acoustic energy.

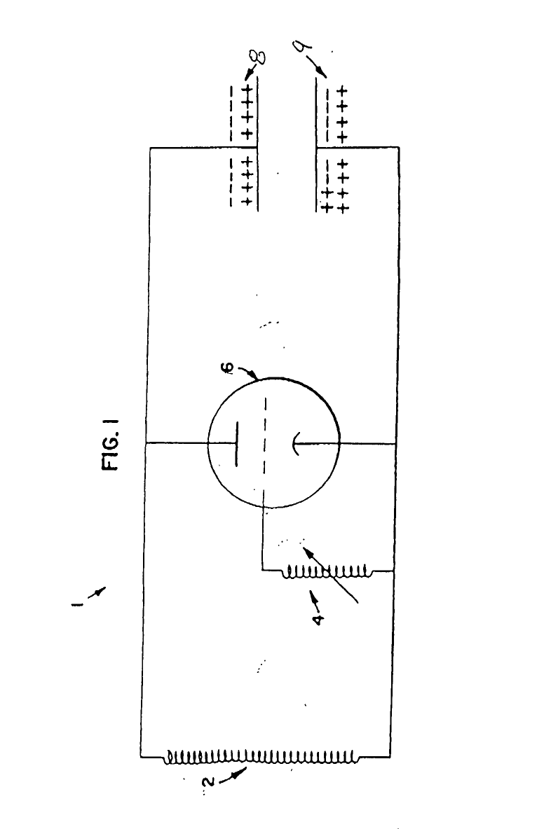

With respect to isocyanate capped polyols for use as implants, radio waves without assistance of sensitizers will adequately mix and polymerize tissue bonds. More generally, with respect to all tissue bonding compositions a modified Hartley circuit for example, and subsequent derivatives are adequate, as shown in FIG. 1. A Hartley circuit 1 may generally comprise a frequency coil 2, tuning coil 4, oscillatory tube 6 and two opposing conductive plates 8 and 9. In use, the bond site is generally positioned between these two plates, 8 and 9, and the energy passes through the sample from the plate to opposing plate.

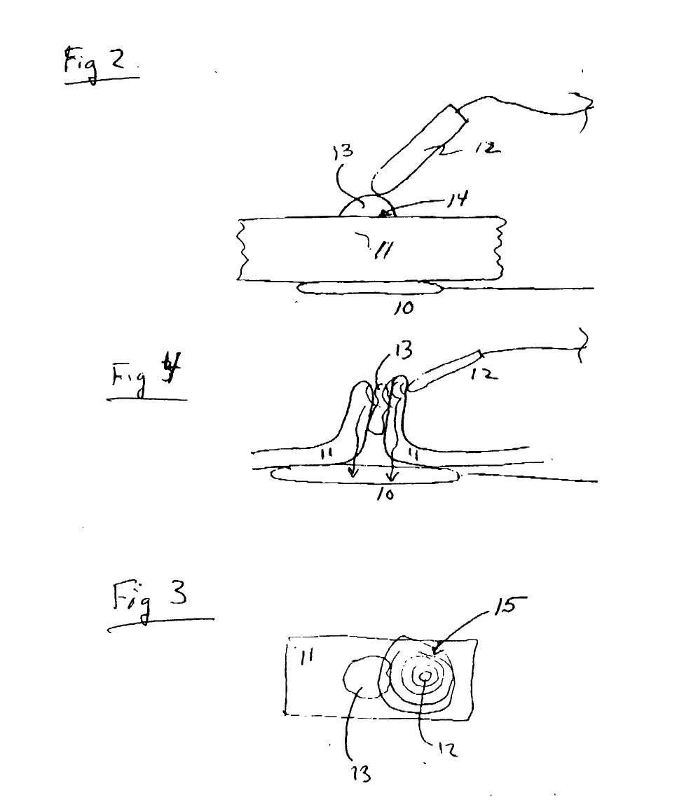

With respective to conductive surfaces, there is shown in FIG. 2, an electrode 10 applied externally to a living organism which is not the reactive surface, since the body 11 acts as a conductor and consequently extends the electrode. The reactive locus occurs between the tissue and the adhesive 13. A second electrode 12 is applied to the adhesive surface, such that the adhesive 13 becomes sandwiched between said electrodes (one of which is the body or tissue). The adhesive then becomes the electrolyte or dielectric between two conductive surfaces and thus the adhesive is preferentially excited by the applied energy. In particular, the adhesive/tissue interface 14, is particularly affected.

While a modified Hartley circuit is possibly the most simple and well known circuit used for the creation of radio waves having the frequency of 1 MHz to about 100 MHz, any other device capable of producing radio waves of this frequency may be used in accordance with the present invention. For example, a coagulation or curring radio frequency device, typically used in the operating room, is suitable though not optimal.

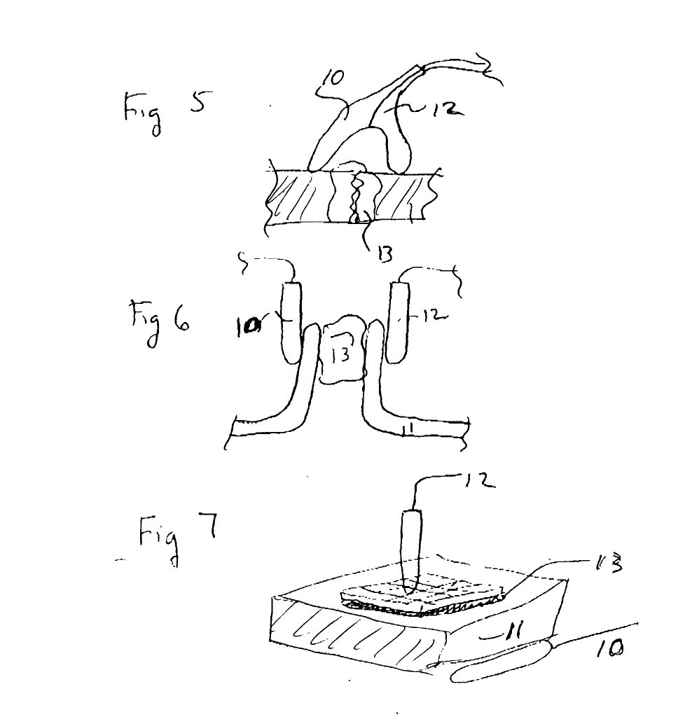

It is of particular interest to note that the adhesive 13 may be positioned outside of the space between opposing conductive surfaces as represented in FIG. 3, so as to be activated by radio waves which typically stray beyond the field created by opposing conductive surface. Stray radio field 15 activation is particularly useful in the bonding of two tissue surfaces, as represented in FIG. 4, which surfaces are conductively connected, e.g., between two tissue surfaces conductively linked.

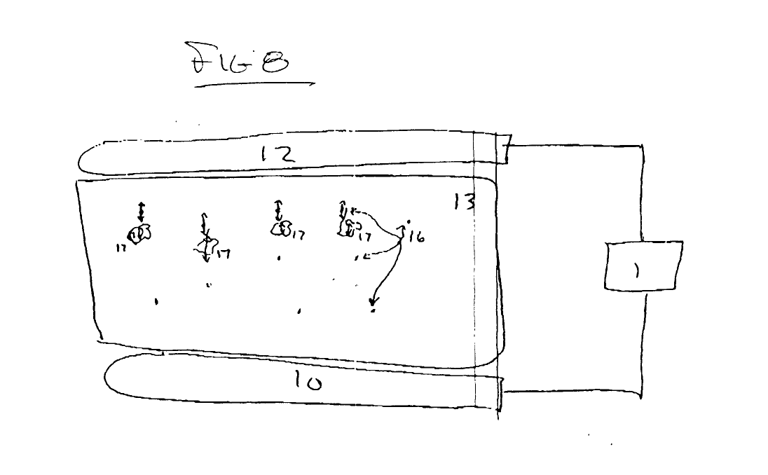

When the adhesive is placed within the field between the two opposing conductive surfaces 10 and 12 as represented in FIGS. 5, 6 and 7, various electrode, adhesive and tissue configurations such as sandwiching shown in FIG. 6, adjacent “triangulation”, as shown in FIG. 5, and electrode 10 spaced alongside the tissue 11 with another electrode 12 in direct contact with the tissue 11, as shown in FIG. 7, may be used in curing the adhesive.

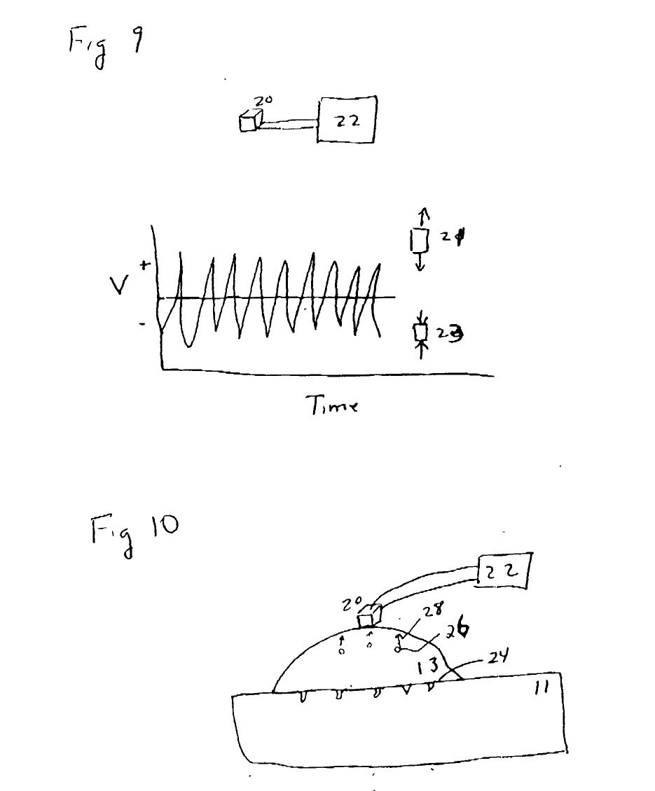

In particular, with respect to a sensitizer, as previously disclosed, the most simple means of activating sensitizers in accordance with the present invention is the use of a modified Hartley circuit 1, represented in FIG. 8, having conductive opposing surfaces 10 and 12. If a sensitizer laden adhesive of the present invention is to be used as an adhesive, two opposing substrates enclosing them will excite the sensitizer 16 and distribute polymerization energy into a portion 17 of the adhesive as represented inn FIG. 8.

The adhesive 13 may be made conductive through the application of embedded conductive foils, fibers, or particles therein. Conductive particles may also be applied by aerosol or pump spray. The affect of these measures would be to make the tissue/adhesive interface particularly active, being a particularly thin, i.e., microscopic, interface and region of excitation.

This design or method of applying radio frequency energy towards the curing of an adhesive is applicable in situations where a two-plate system is not practical due to constraints created by logistic, space, or other considerations which prevent the inclusion of two opposing conductive plates. Generally, the the positive lead is attached to the substrate in which the sensitizer laden adhesive is to be applied so as to provide a proper energy ground so that the radio frequency energy will actually pass through the sensitizer laden adhesive which is laid against first, oppositely positioned conductive plates.

Generally, the sensitizers of the present invention may be activated by a frequency ranging from for example about 1 to 100 MHz, preferably from about 3 to about 80 MHz, and most preferably from about 3 to about 35 MHz. In certain isocyanate capped polyol adhesives, the most effective frequency is 1.5+/−0.3 MHz. For the adhesives disclosed above, the optimal frequency ranges is 24.7-37.2 MHz.

An additional advantage of the present invention is the ability to activate sensitizers and adhesives without the use of high voltage potentials. Specifically, voltages ranging from about 1000 volts to 10,000 volts may be used to activate the adhesive of the present invention. It should be noted that the high voltage is not injurious to tissue since the current applied is adjustably low and the frequency higher then the responsivity of biological systems. Ideally, the voltage is varied in accord with the thickness of the applied adhesive and the desired cure time. However, the present invention allows for a cure initiated with a voltage as low as 100 volts. The actual application time will depend upon the required heat to crosslink at the desired rate as well as the design of the plates used to provide the radio waves and the volume of adhesive. Generally, the time of application will range from for example, about 0.01 to about 1 minute, preferably from about 0.1 to about 15 seconds, and most preferably from about 0.1 to 6 seconds.

In the more general configuration, an acoustic excitation may be employed either independently or in combination with radio frequency excitation. Acoustic excitation is principally an inertial transfer, and creates both kinetic energy excitation and internal displacement within the adhesive.

With respect to mixing, the primary concern is to promote zero porosity by consolidation and elimination of gaseous encapsulation. To achieve this end, ultrasonic vibration of high frequency and low amplitude is ideal. Optimally, a high power density is applied, the pressure amplitude should be 1000 psi or more at displacements less than 100 micron.

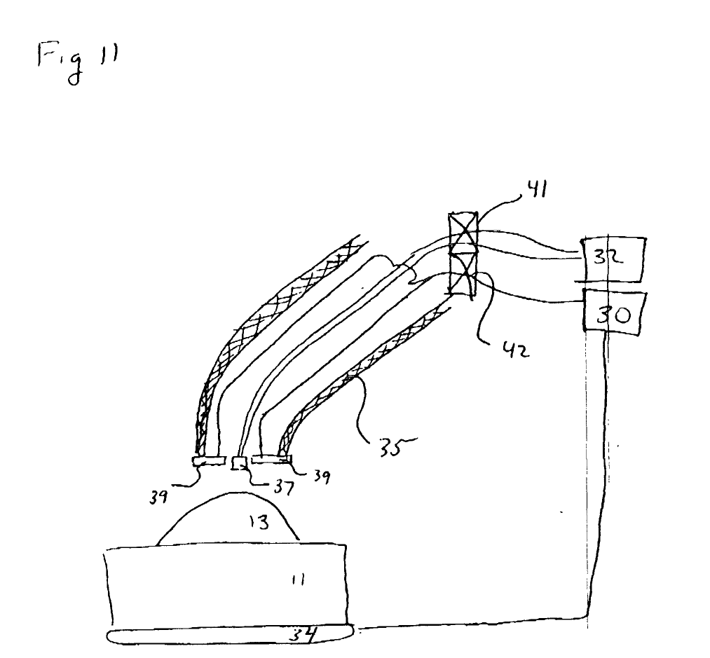

Acoustic energy sources are well known in the art, and typically are configured generally as portrayed in FIG. 9. A piezoelectric crystal 20 is attached to an oscillating potential source 22. The crystal expands 21 and contracts 23 in accordance with the delivered potential. The crystal oscillates with an amplitude related to the frequency and peak potential of the oscillator. Crystal dimensions may be chosen so that the natural resonant frequency of the crystal is matched to the desired acoustic frequency and the oscillator frequency supplied accordingly. In this case the amplitude of the crystal oscillation is related principally to the peak potential of the oscillator, and thus can be adjusted at the chosen frequency.

When one object of applying the acoustic energy is to promote mixing at the tissue/adhesive interface while encouraging release of formed gaseous products, then the wavelength of oscillation should be at least twice the mean diameter of the formed bubbles. FIG. 10 represents the details of mixing at the tissue/adhesive interface 24 and the displacement of formed bubbles 26 in a direction 28 toward the adhesive surface. This application is particularly useful when the adhesive is used to seal tissue, and one surface of the adhesive is not in contact with tissue, as is represented in FIG. 10.

Generally, when acoustic energy is used alone, a sensitizer is not used. When acoustic energy is used in combination with radio frequency energy, a sensitizer may be used. In this case the wavelength of the acoustic energy in the adhesive must be smaller than ½ the mean diameter of the sensitizers. This consideration is important so that the distribution of sensitizer remains uniform within the adhesive.

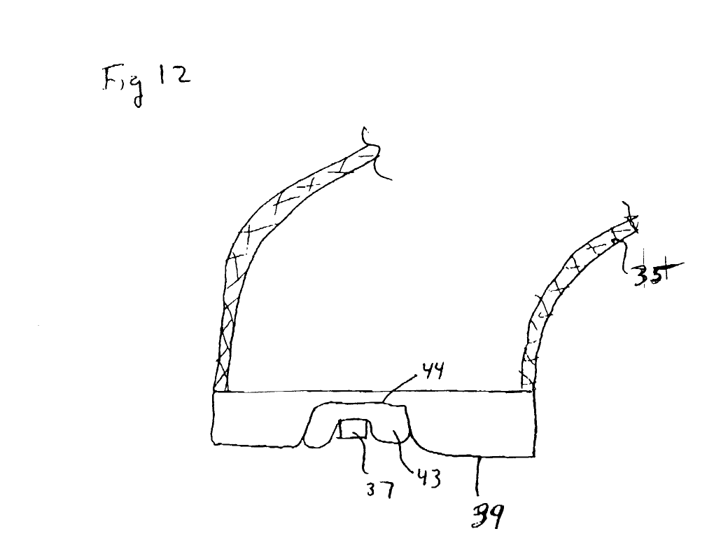

For purposes of illustration, a combined acoustic/radio frequency device is described suitable for practicing the process of the present invention. FIG. 11 shows an embodiment of the invention consisting of radio a frequency generator 30, an acoustic frequency generator 32, a body electrode for the radio frequency generator 34, and curing probe 35 which may be comprised of a surgically robotic arm. The curing probe 35 consists of a piezoelectric crystal 37 and a radio frequency electrode 39 and associated on/off switches 41 (acoustic) and 42 (radio frequency).

The curing probe tip is shown enlarged in FIG. 12. The piezoelectric crystal 37 may be recessed and imbedded in the surface 44 of the radio frequency electrode 39 and separated by an insulator 43 as shown in FIG. 12. It is important that adhesive not be permitted to contact the piezoelectric crystal and is not electrically contacting the electrode, otherwise a substantial portion of the radio frequency energy may be channeled conductively through the crystal causing it to fail.

In this configuration, radio frequency energy and acoustic energy can be applied independently or in combination. Probes may be designed to deliver only one of the two disclosed energy types.

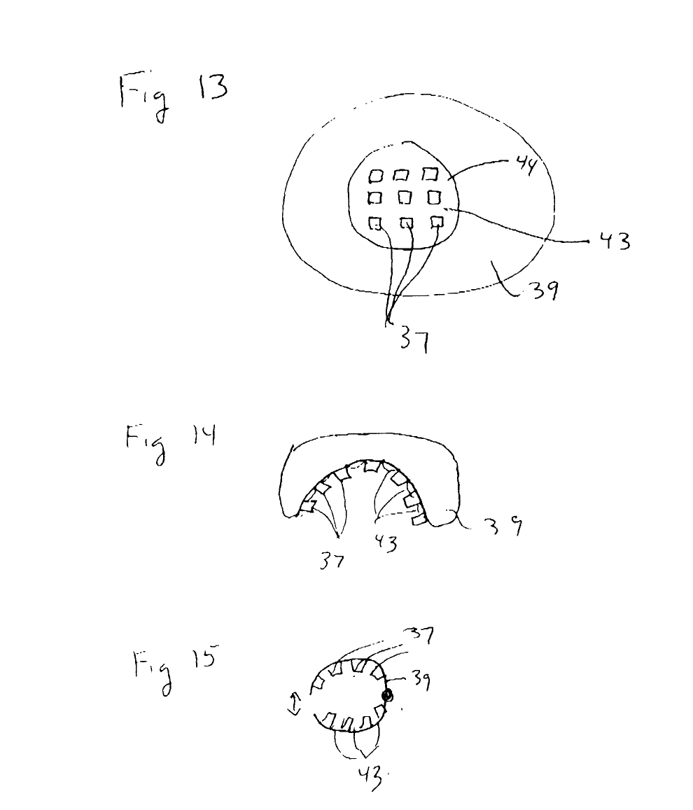

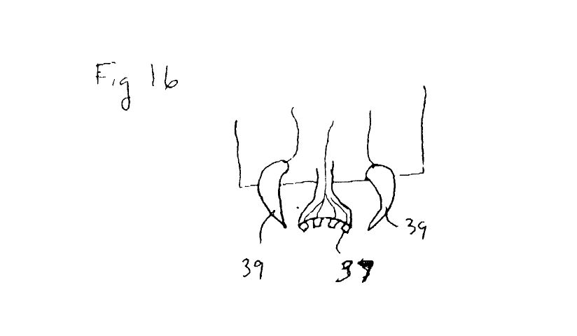

Probe tip design may also be tailored to specific application. For example, when large adhesive surfaces are to be cured simultaneously a large probe tip design is desirable. In the case of the radio frequency electrode, the electrode surface 44 is sized to the desired application. In the case of the piezoelectric crystals, the desired resonance frequency is affected by crystal dimension, and therefore, an array of crystals defining a surface may be chosen. Probe tip designs are various, of which several are given in FIGS. 13-15. In FIG. 13 a flat surface 44 is shown which would be suitable for curing large surfaces, for example in the bonding of a hernia patch to a tissue defect. In FIG. 14 a curved surface is shown which would be suitable for curing tissue joins such as those typically performed during anastomoses. In FIG. 15, a tubular surface is shown which may be arranged to enclose an end-to-end vascular anastomosis.

Bipolar designs are also possible. For instance, in FIG. 16, two electrodes 39 and 39 are presented in the probe tip to produce localized and intense radio frequency excitation of adhesive.

For very specialized applications the probe tip could be configured with a number of electrodes to be selectively activated by an operator or automated means to cure localized portions of a known adhesive/tissue geometry. With respect to the process of decreasing the cure rate of an in situ polymerized implant using radio frequency or acoustic energy and various applications of this process are provided below.

In some applications a slow curing implant is advantageous. For example, in the use of adhesives to fix various patches, and more particularly hernia patches. If the patch is delivered to the treatment site already coated with an adhesive, it is of particular value to be able to adjust its position after placing the patch. A slow curing adhesive satisfies this aspect of the application. However, once adjusted to a preferred orientation it is of value to immediately fix the patch or affix a particular part in order adjust another part. Therefore a method of spot bonding selected portions of the patch to the underlying tissue is advantageous and can be achieved with simple configurations of the present invention.

In other applications an implant is used to seal a standard but typically leaky repair. Examples are vascular anastomoses of all types, the grafting of patches on fluid conducting structures, and the sealing of large cuts placed in organs such as the lungs, liver and kidney. In these instances the standard repair, either by suture or staples, usually is accompanied by some fluid leakage. Rapid curing of the sealant in conjunction with the natural blood coagulating ability of radio frequency energy will make sealant repairs more effective.

In certain repairs the organ is particularly frail and difficult to align with respect to a preferred orientation. For example, in the anastomosis of vascular grafts to coronary arteries both structures are typically “floppy” structures. An in this application, the long-term viability of the graft depends on proper alignment of the two vascular walls. Sutures have traditionally been quite ineffective in such applications since the act of suturing is to align portions of the vessels in a stepwise manner. Thus the difficult procedure of aligning the entire periphery of one vessel to another is avoided. Adhesives are typically relatively slow curing and inappropriate for a stepwise approach to anastomosis alignment. However, adhesive applied generally over the junction locus and then various parts of the vessels brought in ideal apposition can be spot bonded in a stepwise fashion. Once the preferred alignment is established, the generalized curing of the anastomosis interface by the natural cure rate of the glue provides even distribution of forces across the interface. In this way, the localized stresses characteristic of sutures are avoided.

In certain applications the in situ polymerizing agent is employed as a tissue bulker to correct for example faulty valve structures such as the lower esophageal sphincter in GERD and the bladder neck in incontinence. In valve repair treatments which bring tissue into closer proximation aids in one respect the enhancing or re-establishment of a normal valving function, and it is also important to re-establish a normal valve geometry. In particular, particular shapes of bulked tissue are preferred. Various methods are known for temporarily shaping implants. The efficacy and precision of such methods would be enhanced if the implant could be polymerized in the preferred shape on demand. Thus the device of this invention would achieve this “cure on demand” advantage.

The advantages of the present invention are especially realized in robotic and minimally invasive procedures in which a practically limitless tissue joining capability is particularly advantageous since it does not require removal of the tissue manipulating tools from the surgical site. Additionally, robotic devices are particularly well suited for simultaneously aligning tissue and joining tissue which humans typically cannot achieve due to the precision requirements involved. Conversely, surgical robots are uniquely enabled by having a precise, essentially non-mechanical joining technique which create tissue joints on demand.

In other in situ polymerized implant uses, such as those which use an implant as a reservoir for drug release, there is particular value in enhancing the tissue penetrating capacity of an implant prior to polymerization. The mass transport capability associated with acoustic energy is particularly well known. For example, sonic baths are effective cleaning devices. In this invention, the acoustic aspect of the invention can be used to infiltrate tissue, particularly porous tissue, to deliver drugs more intimately to that tissue targeted. For example, an implant designed to hold in place a chemotherapeutic or radiotherapeutic therapy is made more effective by completely infusing the target tissue with the treatment. In this way, lower doses can be used with less unwanted systemic effects. With respect to therapies that are delivered and the implant acts as a reservoir for such delivery, then similarly the dose of the drug delivery and/or the duration of the effectiveness of the reservoir quantity can be optimized when the implant can be implanted intimately with the target tissue.

It is to be understood that this invention is not limited to particular surgical adhesive formulations or process parameters. It is also to be understood that the terminology used herein is for the purpose of describing particular embodiments only, and is not intended to be limiting

1. A curing device for promoting polymerization of a medical implant site in mammalian tissue, consisting of:
a radio frequency energy source and pair of radio frequency electrodes; and an acoustic energy source and a mechanical oscillator.

2. The curing device of claim 1, wherein said curing device consists of a radio frequency energy source and a pair of electrodes.

3. The curing device of claim 1, wherein said curing device consists of an acoustic energy source and a mechanical oscillator.

4. The curing device of claim 1, wherein said mechanical oscillator comprises a piezoelectric crystal.

5. The curing device of claim 1, wherein one of said pair of radio frequency energy electrodes is attached distal to the implant site and generally electrically coupled to skin; and
the other of said pair of radio frequency electrodes forms an element of a probe for selective excitation of the implant site.

6. The curing device of claim 1, wherein both of said pair of radio frequency energy electrodes are arranged on a probe for locally affecting implant cure in said implant site.

7. The curing device of claim 1, wherein said device is arranged on a surgical robotic arm.

8. The curing device of claim 1, wherein said radio frequency energy electrodes have a shaped distal surface to affect a particular shaped surgical repair site.

9. The curing device of claim 1, wherein said radio frequency energy ranges from 1 to 100 MHz.

10. The curing device of claim 1, wherein said radio frequency energy ranges from 1 to 3 MHz and said device includes an in situ polymerizing agent comprised of a polyisocyanate capped polyol.

11. The curing device of claim 1, wherein the radio frequency energy source has a potential peak ranging from 100 to 10,000 volts.

12 The curing device of claim 1, which includes a sensitizer in said implant site, and wherein said acoustic energy source emits a traveling wave in said implant site having a wavelength which is at least twice the diameter of said sensitizer present in said implant.

13. A process for increasing the speed of polymerization in an in situ polymerizing compound at a mammalian implant site, comprising the steps of:
application to tissue of an in situ polymerizing agent; and
excitation of said in situ polymerizing agent with either a radio frequency signal or an acoustic energy signal.

14. The process of claim 13, including the step of:
coagulating blood in said implant site by said energy signal.

15. The process of claim 13, including the step of:
enhancing the implant excitation efficacy of said polymerzing compound by adding a sensitizer to said compound.

16. The process of claim 15, wherein said sensitizer is a phosphonated compound having a phosphate-oxygen bond having a dipole moment receptive to radio frequency energy.

17. The process of claim 16, wherein the concentration of said phosphonated compound ranges from 0.1 wt-% to 25 wt-%.

18. The process of claim 13, wherein said in situ polymerizing agent comprises a polyisocyanate capped polyol.

19. The process of claim 13, wherein said in situ polymerizing agent includes a glutaraldehyde polymerization step.

20. The process of claim 13, wherein said in situ polymerizing agent includes an activated polyethylene glycol.

21. The process of claim 13, wherein said in situ polymerizing agent includes a cyanoacrylate.

22. The process of claim 13, wherein said in situ polymerizing agent includes fibrin.

23. The process of claim 13, wherein said in situ polymerization and treatment of tissue is performed with a robotic surgical platform.

24. The process of claim 13, includes the step of:
shaping said polymerized implant before said implant is polymerized.

25. The process of claim 13, wherein said polymerization is accomplished in a stepwise fashion.

26. The process of claim 13, wherein said polymerized implant is caused to infiltrate target tissue by an application of acoustic energy thereto.
